(19) United States
(12) Patent Application Publication
(10) Pub. No.: US 2012/0303707 A1
(43) Pub. Date: Nov. 29, 2012

(54) COMPUTER AND METHOD FOR REMOTELY SHARING OPERATIONS OF THE COMPUTER WITH AN ELECTRONIC DEVICE

(75) Inventors: LIU-WEI WU, Tu-Cheng (TW); HSIN-CHANG LAI, Tu-Cheng (TW); JIUN-RU HOU, Tu-Cheng (TW)

(73) Assignee: CHI MEI COMMUNICATION SYSTEMS, INC., Tu-Cheng (TW)

(21) Appl. No.: 13/451,410

(22) Filed: Apr. 19, 2012

(30) Foreign Application Priority Data
May 25, 2011 (TW) 100118207

(51) Int. Cl. G06F 15/16

(52) U.S. Cl. 709/204

(57) ABSTRACT

In a method of remotely sharing operations of a computer with an electronic device, the method monitors when a clipboard operation is performed on the computer, and sends information as to the nature of the clipboard operation and content of the clipboard operation to the electronic device. If the electronic device supports the required operation, the electronic device executes a relevant action based on the clipboard operation required and the content.

### BACKGROUND

1. Technical Field

Embodiments of the present disclosure generally relate to remote control devices and methods, and more particularly to a computer and a method for remotely sharing operations of the computer with an electronic device.

2. Description of Related Art

When a user edits text on a display of a mobile phone, speed of editing the text may be very slow. The user also can use a computer to edit the text, and then copy the text from the computer to the mobile phone. In such a manner, the user can edit the text using the computer, save the text in a secure digital memory (SD) card, and then copy the text from the SD card to the mobile phone. During the editing, the words of the edited text must be sent to the mobile phone intermittently and very often. The method is inconvenient and complicated. Therefore, a method for remotely sharing operations of the computer with the electronic device is desirable.

### BRIEF DESCRIPTION OF THE DRAWINGS

FIG. 1 is a block diagram of one embodiment of a computer including an operation unit that is in electronic communication with an electronic device including a sharing unit.

FIG. 2 is a block diagram illustrating software modules of the operation unit and the sharing unit in FIG. 1.

FIG. 3 is a block diagram illustrating a data flow between the computer and the electronic device in FIG. 1.

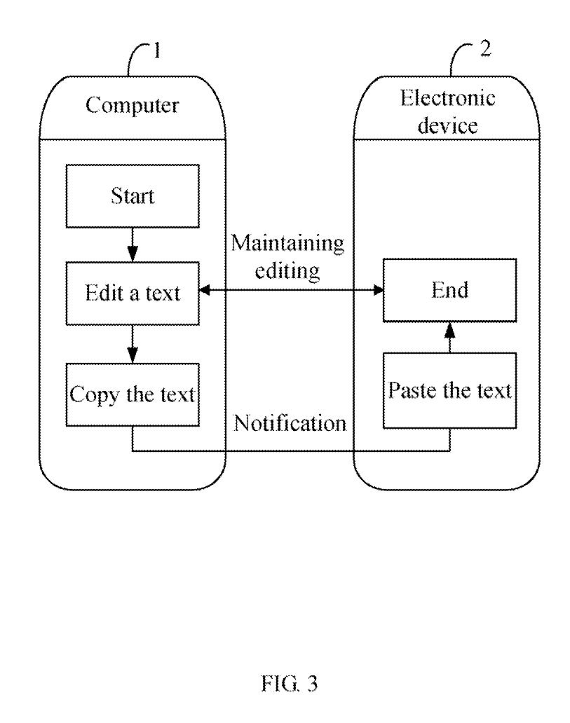

FIG. 4 is a flowchart illustrating one embodiment of a remote operation sharing method performed by a computer.

FIG. 5 is a flowchart illustrating one embodiment of a remote operation sharing method performed by an electronic device.

### DETAILED DESCRIPTION

In general, the word “module,” as used herein, refers to logic embodied in hardware or firmware, or to a collection of software instructions, written in a programming language, such as, for example, Java, C, or assembly. One or more software instructions in the modules may be embedded in firmware, such as in an EPROM. Modules may comprise connected logic units, such as gates and flip-flops, and may comprise programmable units, such as programmable gate arrays or processors. The modules described herein may be implemented as either software and/or hardware modules and may be stored in any type of non-transitory computer-readable medium or other computer storage device.

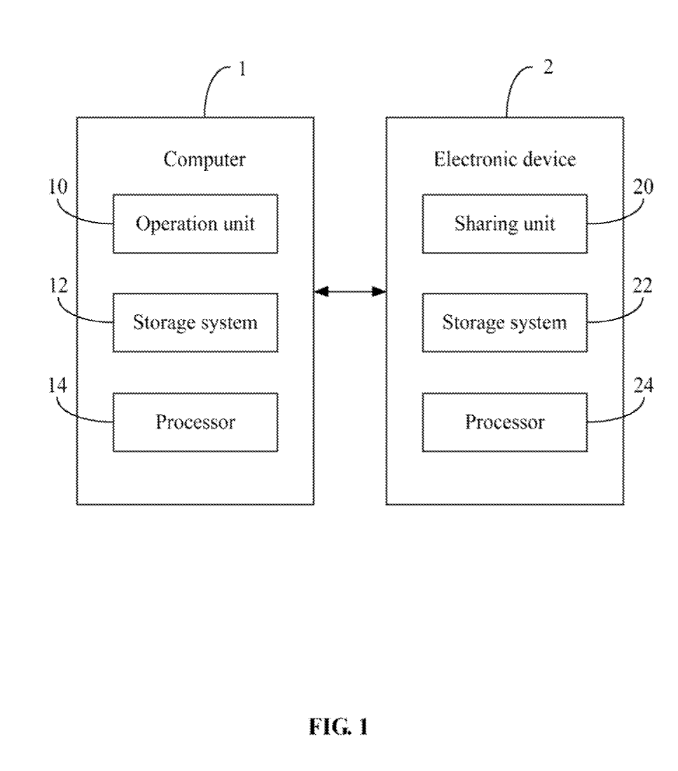

FIG. 1 is a block diagram of one embodiment of a computer 1 in electronic communication with an electronic device 2. In the embodiment, the computer 1 electronically communicates with the electronic device 2 via a WIFI network or an ANDROID debug bridge. In one embodiment, the electronic device 2 may be a TV, a portable electronic device, or any other computing device that does not include a physical keyboard.

In the embodiment, the computer 1 includes an operation unit 10, a storage system 12, and at least one processor 14. The electronic device 2 includes a sharing unit 20, a storage system 22, and at least one processor 24.

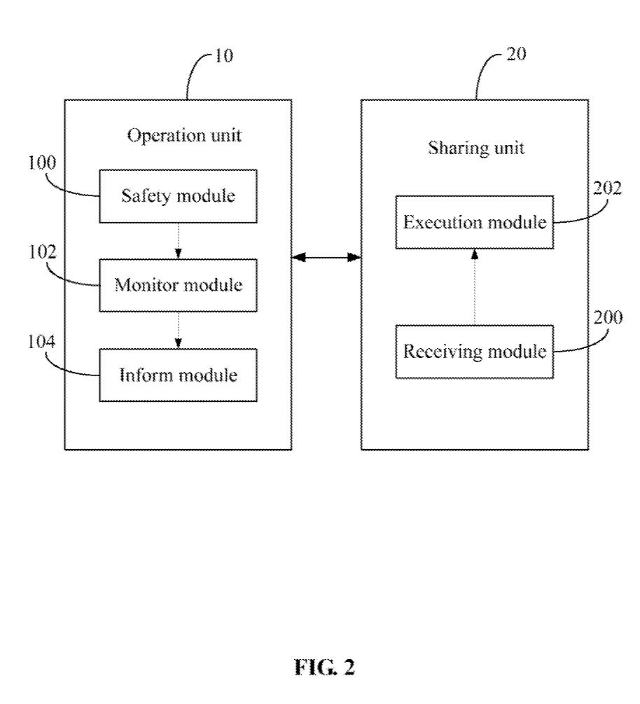

As shown in FIG. 2, the operation unit 10 includes a safety module 100, a monitor module 102, and an inform module 104. The sharing unit 20 includes a receiving module 200 and an execution module 202. Each of the modules 100-104 is a software program including one or more computerized instructions that are stored in the storage system 12 and executed by the at least one processor 14. Each of the modules 200-202 is a software program including one or more computerized instructions that are stored in the storage system 22 and executed by the processor 24. In the embodiment, the storage system 22 also stores operations that can be performed by the electronic device 2.

The safety module 100 searches one or more electronic devices 2 around the computer 1 in a wireless network (e.g., WIFI network), and selects one of the searched electronic devices 2 according to an identification information (e.g., a model number) of the electronic device 2. In one embodiment, the model number is provided by a manufacturer of the one or more electronic devices 2, and is an identifier that indicates a particular type of the one or more electronic devices 2. The searching may use the electronic device 2 that is required to communicate with the computer 1.

The monitor module 102 monitors a clipboard operation of the computer 1. In the embodiment, the clipboard operation is an operation of a user that indicates the user inputting or copying content (e.g., text or images) in a clipboard of the computer 1. In one embodiment, the clipboard operation may be an editing operation or a copy operation, for example.

Upon the condition that a clipboard operation has been performed on the computer 1, the inform module 104 detects whether the electronic device 2 supports the clipboard operation by detecting whether the storage system 22 stores the clipboard operation. For example, the electronic device 2 may support an operation of copying and editing a text or a picture, but may not support an operation of copying and editing of a document or file.

If the electronic device 2 supports the clipboard operation, the inform module 104 notifies the electronic device 2 (“the notification”) that the computer 1 is performing the clipboard operation, and instructs the electronic device 2 to execute a relevant action corresponding to the clipboard operation performed by the computer 1. In the embodiment, the notification includes the clipboard operation and content (e.g., text) related to the clipboard operation. In other words, the inform module 104 tells the electronic device 2 what the computer 1 has done.

Upon the condition that the receiving module 200 has received the notification, the execution module 202 executes the relevant action in the electronic device 2. In one embodiment, the relevant action may be an editing action or a pasting action. For example, as shown in FIG. 2, supposing that the operation is a copy operation, the relevant action executed by the execution module 202 is a pasting action. If the operation is an editing operation, the relevant action may be an editing action.

In another embodiment, if the electronic device 2 does not receive (e.g., the electronic device 2 does not receive the notification because distance between the computer 1 and the electronic device 2 is too long because of a weak network) or cannot identify the notification (a format of the notification cannot be identified by the electronic device 2), the execution module 202 abandons the instruction from the inform module 104 and any operation content and makes no reply to the instruction notification. In one embodiment, if a format for the content related to the clipboard operation, or the clipboard operation itself in the instruction notification cannot be identified by the electronic device 2, the execution module 202 makes no reply to the instruction notification. The content may be text, a picture, an image, or a video recording, for example.

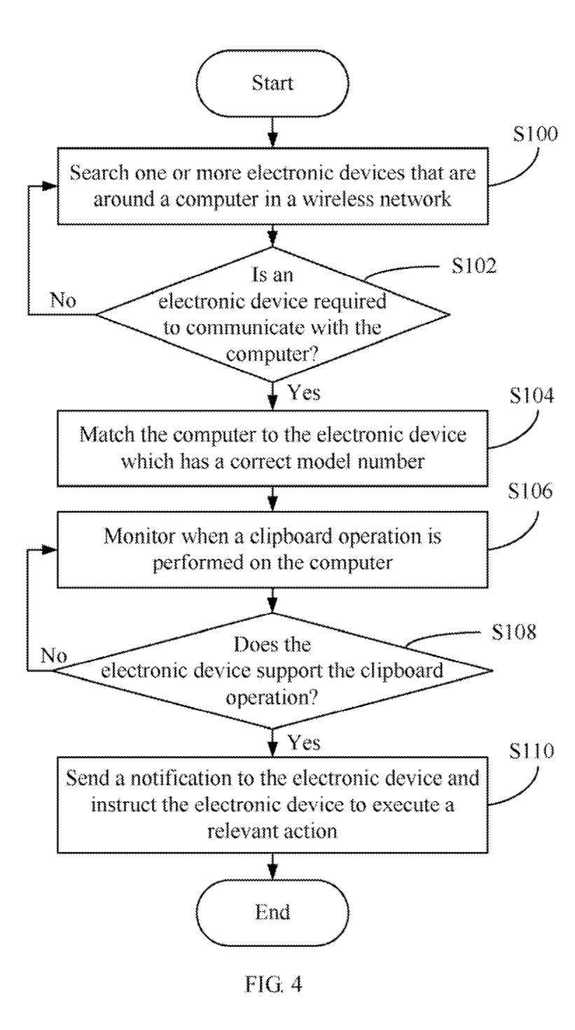

FIG. 4 is a flowchart illustrating one embodiment of a remote operation sharing method performed by the computer 1. Depending on the embodiment, additional blocks may be added, others removed, and the ordering of the blocks may be changed.

In step S100, the safety module 100 searches one or more electronic devices 2 around the computer 1 in a wireless network (e.g., WIFI network), and records a device recording list in respect of all the electronic devices 2 which were found in the search.

In step S102, the safety module 100 determines whether the electronic device 2 in the device recording list is required to communicate with the computer 1. In one example, the electronic device 2 is a mobile phone. If one electronic device 2 is found, that is, the device recording list has been recorded, the flow goes to step S104. If no electronic device 2 has been found, the flow returns to step S100.

In step S104, the safety module 100 matches the computer 1 to the electronic device 2 that is able to communicate with the computer 1 using a correct model number. In the embodiment, the model number is provided by a manufacturer of the one or more electronic devices 2, and is an identifier that indicates a particular type of the one or more electronic devices 2.

In step S106, the monitor module 102 monitors when a clipboard operation is performed on the computer 1. If a clipboard operation is performed on the computer 1, in step S108, the monitor module 102 takes control of the clipboard operation and determines whether the electronic device 2 supports the clipboard operation. For example, the monitor module 102 can detect whether the electronic device 2 has a function of performing the clipboard operation. In the embodiment, the operations that can be performed by the electronic device 2 are pre-set in the storage system 22.

Upon the condition that the electronic device 2 does not support the clipboard operation, the flow returns to the step S106. For example, the electronic device 2 supports an operation of copying and editing a text or a picture, but does not support an operation of copying and editing a document or file.

Upon the condition that the electronic device 2 supports the clipboard operation, in step S110, the inform module 104 sends a notification (hereinafter “instruction notification”) to the electronic device 2 for notifying that the computer 1 is performing the clipboard operation, and instructs the electronic device 2 to execute a relevant action according to the notification. In the embodiment, the notification includes the clipboard operation and content related to the clipboard operation.

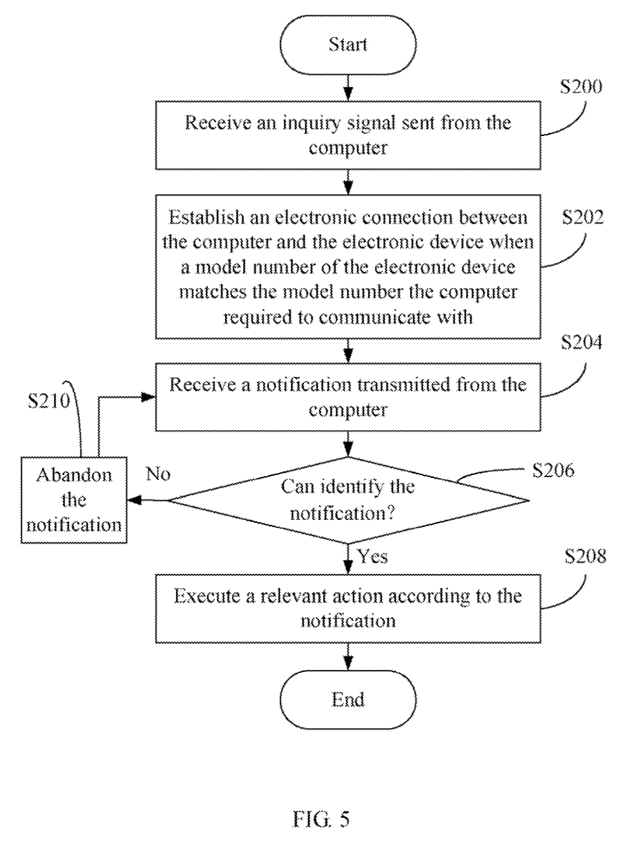

FIG. 5 is a flowchart illustrating one embodiment of a remote operation sharing method performed by the electronic device 2, such as the mobile phone, for example. Depending on the embodiment, additional blocks may be added, others removed, and the ordering of the blocks may be changed.

In step S200, the receiving module 200 receives an inquiry signal sent from the computer 1.

In step S202, the receiving module 200 establishes an electronic connection between the computer 1 and the electronic device 2, upon the condition that the model number of the electronic device 2 matches and satisfies the model number the computer 1 required to communicate with.

In step S204, the receiving module 200 receives the instruction notification transmitted from the computer 1.

In step S206, the receiving module 200 determines whether the instruction notification can be acted upon. For example, the receiving module 200 determines whether or not the format of the content of the instruction notification is within the capabilities of the electronic device 2. In one embodiment, the format may be in respect of text, pictures, images, or video recordings, for example.

Upon the condition that the electronic device 2 is capable of performing the instruction notification, in step S208, the execution module 202 executes a relevant action according to the instruction notification. For example, if the operation is copying the text from the clipboard of the computer 1, the relevant action executed by the execution module 202 is pasting the text correspondingly, into an automatic document for example, in the electronic device 2. If the operation is an editing operation, the relevant action may be an editing action.

In step S210, if the electronic device 2 does not receive, or cannot identify the instruction notification, the execution module 202 abandons the instruction notification and content of the operation, and makes no reply to the instruction notification.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method of a computer for remotely sharing operations with an electronic device, the method comprising:
searching one or more electronic devices around the computer in a wireless network;
selecting one of the searched electronic devices according to an identification information of the electronic device;
monitoring when a clipboard operation is performed on the computer;
upon the condition that a clipboard operation is performed on the computer, determining whether the electronic device supports the clipboard operation by detecting whether the clipboard operation is stored in a storage system of the electronic device;
sending a notification to the electronic device, upon the condition that the electronic device supports the clipboard operation, the notification comprising the clipboard operation and content related to the clipboard operation; and
instructing the electronic device to execute a relevant action according to the notification.

2. The method as described in claim 1, wherein the clipboard operation is an editing operation or a copy operation, and the relevant action is an editing action or a pasting action.

3. The method as described in claim 1, wherein the content related to the clipboard operation comprise text, a picture, an image, or a video recording.

4. The method as described in claim 1, further comprising:
abandoning the notification and the content related to the clipboard operation and making no reply to the notification, upon the condition that the electronic device does not receive the notification and does not identify the notification.

5. The method as described in claim 1, further comprising:
returning to monitor whether a clipboard operation is performed on the computer, upon the condition that no clipboard operation is performed on the computer.

6. The method as described in claim 1, wherein the wireless device is a WIFI network or an ANDROID debug bridge.

7. The method as described in claim 1, wherein the electronic device is a TV, a portable electronic device, or a computing device.

8. A computer, comprising:
at least one processor;
a storage system; and
one or more modules that are stored in the storage system and executed by the at least one processor, the one or more modules comprising:
a safety module that searches one or more electronic devices around the computer in a wireless network, and selects one of the searched electronic devices according to an identification information of the electronic device;
a monitor module that monitors when a clipboard operation is performed on the computer; and
an inform module that determines whether the electronic device supports the clipboard operation by detecting whether the clipboard operation is stored in a storage system of the electronic device, sends a notification comprising the clipboard operation and content related to the clipboard operation to the electronic device upon the condition that the electronic device supports the clipboard operation, and instructs the electronic device to execute a relevant action according to the notification.

9. The computer as described in claim 8, wherein the clipboard operation is an editing operation or a copy operation, and the relevant action is an editing action or a pasting action.

10. The computer as described in claim 8, wherein the content related to the clipboard operation comprise text, a picture, an image, or a video recording.

11. The computer as described in claim 8, wherein the electronic device abandons the notification and the content related to the clipboard operation and makes no reply to the notification, upon the condition that the electronic device does not receive the notification and does not identify the notification.

12. The computer as described in claim 8, wherein the wireless device is a WIFI network or an ANDROID debug bridge.

13. The computer as described in claim 8, wherein the electronic device is a TV, a portable electronic device, or a computing device.

14. A non-transitory computer-readable storage medium having stored thereon instructions that, when executed by a processor of a computer, causes the processor to perform a method for remotely sharing operations of the computer with an electronic device, the method comprising steps of:
searching one or more electronic devices around the computer in a wireless network;
selecting one of the searched electronic devices according to an identification information of the electronic device;
monitoring when a clipboard operation is performed on the computer;
upon the condition that a clipboard operation is performed on the computer, determining whether the electronic device supports the clipboard operation by detecting whether the clipboard operation is stored in a storage system of the electronic device;
sending a notification to the electronic device, upon the condition that the electronic device supports the clipboard operation, the notification comprising the clipboard operation and content related to the clipboard operation; and
instructing the electronic device to execute a relevant action according to the notification.

15. The storage medium as described in claim 14, wherein the clipboard operation is an editing operation or a copy operation, and the relevant action is an editing action or a pasting action.

16. The storage medium as described in claim 14, wherein the content related to the clipboard operation comprise text, a picture, an image, or a video recording.

17. The storage medium as described in claim 14, wherein the method further comprises:
abandoning the notification and the content related to the clipboard operation and making no reply to the notification, upon the condition that the electronic device does not receive the notification and does not identify the notification.

18. The storage medium as described in claim 14, wherein the method further comprises:
returning to monitor whether a clipboard operation is performed on the computer, upon the condition that no clipboard operation is performed on the computer.

19. The storage medium as described in claim 14, wherein the wireless device is a WIFI network or an ANDROID debug bridge.

20. The storage medium as described in claim 14, wherein the electronic device is a TV, a portable electronic device, or a computing device.
